(19) United States
(12) Patent Application Publication
(10) Pub. No.: US 2014/0317406 A1
(43) Pub. Date: Oct. 23, 2014

(54) COMMUNICATION BETWEEN NETWORK NODES THAT ARE NOT DIRECTLY CONNECTED

(71) Applicant: Beep, Inc., San Francisco, CA (US)

(72) Inventors: Shawn Lewis, San Francisco, CA (US); Dean Blackketter, San Francisco, CA (US); Daniel R. Conrad, San Francisco, CA (US)

(73) Assignee: Beep, Inc., San Francisco, CA (US)

(21) Appl. No.: 14/256,200

(22) Filed: Apr. 18, 2014

Related U.S. Application Data
(60) Provisional application No. 61/814,733, filed on Apr. 22, 2013.

(51) Int. Cl. G06F 21/60

(52) U.S. Cl. CPC G06F 21/602
USPC 713/170

(57) ABSTRACT

A first node sends a sequence of packets to another node to which it is connected over a communication network. A second node monitors network traffic in the communication network and intercepts the sequence of packets in the network traffic sent by the first node. The second node decodes a message in the sequence of packets intended for the second node, wherein the message is encoded using lengths of the packets in the sequence of packets.

### RELATED APPLICATIONS

This application claims the benefit of U.S. Provisional Patent Application No. 61/814,733, filed Apr. 22, 2013, the contents of which are hereby incorporated by reference herein.

### TECHNICAL FIELD

This disclosure relates to the field of network communication and, in particular, to communication between network nodes that are not directly connected.

### BACKGROUND

Computing devices are often connected to communications networks, including wireless and electrically-wired networks. These networks may use encryption to protect the data transmitted between devices from eavesdropping and insertion of data by devices that do not have the encryption keys. Devices using encrypted communications, however, may not be able to communicate to devices outside the encrypted network.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary network architecture in which embodiments of the present disclosure may be implemented.

FIG. 2 is a block diagram illustrating an encoder/decoder, according to an embodiment.

FIG. 3 is a block diagram illustrating a network packet, according to an embodiment.

FIG. 4 is a flow diagram illustrating a method for communication of device operating in a station mode, according to an embodiment.

FIG. 5 is a flow diagram illustrating a method for communication of device operating in a monitor mode, according to an embodiment.

FIG. 6 is a flow diagram illustrating a method for communication network setup, according to an embodiment.

FIG. 7 is a block diagram illustrating an exemplary computer system, according to some embodiments.

### DETAILED DESCRIPTION

Embodiments are described for communication between network nodes that are not directly connected. A network is a group of electronic devices, or nodes, connected to each other by communication channels, or connections, that allow the sharing of information. In wireless networks, nodes are not connected by cables, but signals are transmitted using radio waves.

In one embodiment, a wireless network includes of nodes and connections between the nodes. For nodes to share messages, they typically must first establish a connection. The method for establishing a connection between two nodes may be determined by the networking standard employed. The establishment of a connection between two wireless devices typically involves the exchange of information required to establish a shared encryption scheme, which will allow the nodes to share information without allowing that information to be available to eavesdroppers using the same electromagnetic spectrum.

In some cases, it may be useful to share information between two nodes which are not connected, and are therefore not part of the same network. Furthermore, it may be that one of those two non-connected nodes may be connected to another network. As an example, it may be useful for a smartphone, or other user device, which is connected to a Wi-Fi access point to send a Wi-Fi network password to a third party device which is not connected to that access point, so that the third party device may establish a connection to the same access point. In a traditional Wi-Fi network, no information sharing would be possible from the phone to the third party device, because no connection or chain of connections exists between the phone and the device.

Described herein are techniques for the communication of messages between nodes without requiring the establishment of a connection between those nodes. Furthermore, these techniques allow communication between two connected nodes to be received and interpreted by a third node which is not connected to either of those two nodes. In one embodiment, the messages communicated using these techniques may be referred to as “out-of-band” messages.

Embodiments of the system described herein permit network nodes connected to an encrypted network to send messages to other nodes outside that network by transmitting a set of carefully crafted packets. A device not connected to the encrypted network may be able to capture the encrypted packets, where the timing pattern of transmission of these packets and their characteristics (e.g., the packet length) may encode information independent of the encrypted data in the packet. This information can be decoded by the capturing device into a useful message.

As an example, a station device on an encrypted Wi-Fi network may transmit a series of User Datagram Protocol (UDP) packets to another device on the encrypted network with a pattern of specific packet lengths. Another Wi-Fi device, not necessarily associated with any network, can listen for encrypted packets in a transmission channel, capture the encrypted packets, detect the transmission pattern and extract information from the packet lengths and timing. In other embodiments, some other network may be used besides Wi-Fi, such as Bluetooth, GSM, CDMA, or a wired network (e.g. Ethernet).

In other embodiments, the system can be generalized to work on any network where traffic may be broadcast or intercepted, including wireless encrypted and unencrypted networks (including, but not limited to 802.11 Wi-Fi networks, 802.15 Bluetooth or 802.15.4 Zigbee networks) as well as wired networks protected by encrypted channels, such as virtual private networks (VPNs) or Ethernet networks.

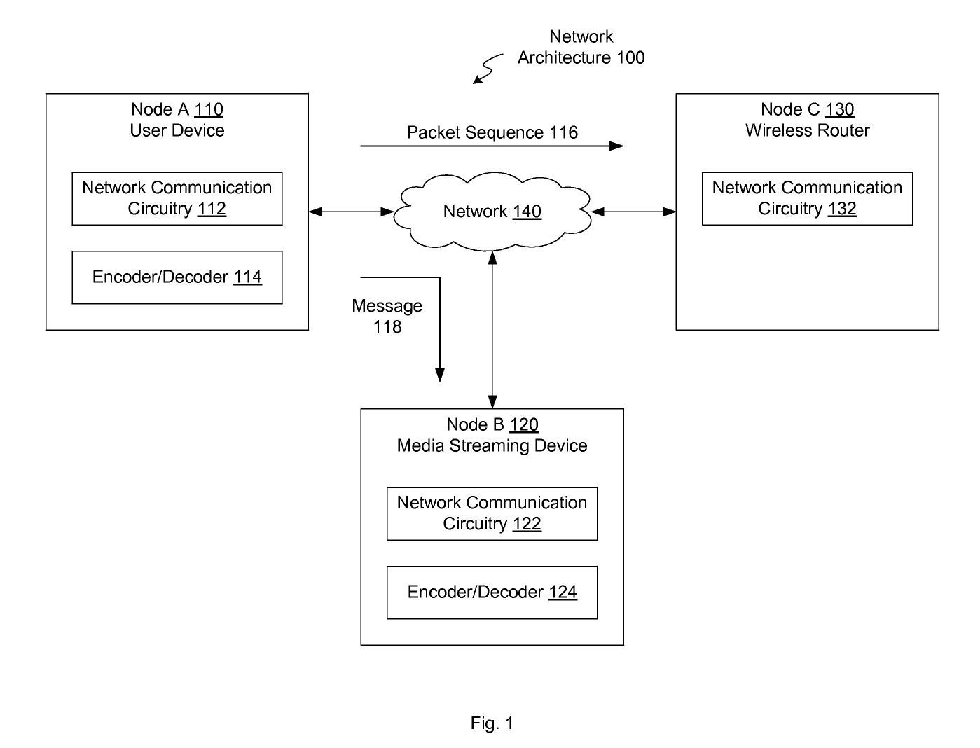

FIG. 1 is a block diagram illustrating an exemplary network architecture 100 in which embodiments of the present disclosure may be implemented. In one embodiment, the network architecture 100 includes node A 110, node B 120 and node C 130, connected by a network 140. In one embodiment, network 140 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Each of node A 110, node B 120 and node C 130 may include a computing device such as a server, personal computer (PC), laptop, mobile phone, smart phone, tablet computer, netbook computer, media device, router, hub, switch, etc. In one embodiment, for purposes of illustration, node A 110 may be a user device, such as a smart phone, node B 120 may be a media streaming device, and node C 130 may be a wireless network router. It should be understood that in other embodiments, node A 110, node B 120 and node C 130 may include some other combination of these or different electronic devices. Node A 110, node B 120 and node C 130 may include any electrical device that is capable of sending, receiving, or forwarding information over a communications channel. One or more applications may be running on a node at any given time, and these applications may share the node's communication channel.

In one embodiment, each of node A 110, node B 120 and node C 130 include network communication circuitry 112, 122, 132, respectively. Network communication circuitry 112, 122, 132 may include hardware and/or software modules designed to facilitate communication across network 140. For example, network communication circuitry 112, 122, 132 may include a wireless radio or modem to allow the node to communicate via a wireless network and/or with other computing devices. The wireless modem may allow the node to handle both voice and non-voice communications (such as communications for text messages, multimedia messages, media downloads, web browsing, etc.) with the wireless communication system. The wireless modem may provide network connectivity using any type of mobile network technology including, for example, cellular digital packet data (CDPD), general packet radio service (GPRS), enhanced data rates for GSM evolution (EDGE), universal mobile telecommunications system (UMTS), 1 times radio transmission technology (1×RTT), evaluation data optimized (EVDO), high-speed downlink packet access (HSDPA), Wi-Fi, etc. The wireless modem may generate signals and send these signals to power amplifier (amp) for amplification, after which they are wirelessly transmitted via an antenna. In addition to sending data, the antenna also receives data, which is sent to the wireless modem and transferred for further processing.

In one embodiment, network communication circuitry 112 in node A 110 is configured to transmit a packet sequence 116 to node C 130 across network 140. Network communication circuitry 132 in node C 130 may receive the packet sequence 116, decrypt the packets in the packet sequence (if encrypted) and forward the data contained therein to one or more applications on node C 130 for further processing.

Encryption is the process of encoding messages or information so that eavesdroppers cannot read it, but authorized parties are able to do so. Encryption is used to protect data in transit in a network. An encryption key or keys are typically used to specify how the data should be encoded. Both the sender and receiver of an encrypted message have knowledge of the encryption key. A packet is a formatted unit of digital data, used for communication across a network connection, which can contain control information, such as an identifier of the sender of the packet, and of the intended target of the packet. Packets may also contain a payload (such as a message or piece of a message). The packet length may include the number of bytes of data (or other unit) in a given packet.

Because wireless signals are transmitted in free space, all packets sent between connected wireless nodes may be visible to other wireless nodes which are within range of the radio transmissions. However, a connection may be encrypted so that only nodes which are connected to the same network will have the necessary key to decrypt the message transmitted. Encryption of messages is typical on wireless networks. Therefore, with standard wireless networking methods, nodes can establish a connection before any messages may be shared between those nodes. Any communication between nodes can then be sent over that connection.

In a typical Wi-Fi network, nodes may assume a mode and may switch between modes. In some embodiments, a node may assume more than one mode at the same time, or a node may cycle through different modes over time. There are situations in which it may not be possible for an application to change which mode a node is in, or to change which access point a station is connected to.

Some common modes in Wi-Fi networks include an Access Point Mode and a Station Mode (or Client Mode). In one embodiment, a node in the access point mode (e.g., node C 130) can establish connections with multiple nodes that are in the station mode (e.g., node A 110). Nodes in the access point mode may be responsible for routing data between some or all nodes in station mode and to other networks to which they may be connected using a different networking technology (e.g., Ethernet). In one embodiment, a node in station mode (e.g., node A 110) can establish a single Wi-Fi connection with a node in access point mode (e.g., node C 130). In a typical Wi-Fi network, a node in station mode can communicate directly only with the node in access point mode with which it has established a connection. To communicate with another node in station mode, node A 110 may send the data to the node in access point mode, along with the MAC address of the target station, so that the access point can route the data to the target node, which may also be connected to the same node in access point mode.

In one embodiment, a third mode of operation for network nodes may exist, which may be referred to as monitor mode. A node in monitor mode (e.g., node B 120) is able to receive all Wi-Fi network packets transmitted in a given radio frequency, or channel in network 140, including those packets sent by nodes to which the node in monitor mode is not connected (such as between node A 110 and node C 130). However, if the network traffic is encrypted, as is typical, nodes in monitor mode cannot decrypt the message embedded in the network traffic.

While a node in monitor mode cannot decrypt encrypted messages for which it does not have the key, it does have access to additional pieces of information that are available for all packets. Packet information visible to a node in monitor mode includes the payload length (i.e., the number of bytes of data contained in the payload of a given packet), the MAC address of the sending node, the MAC address of the Access Point, and potentially other characteristics or information.

Where the MAC address of the sending node is not encrypted and is therefore available to a node in monitor mode (as is typical with Wi-Fi networking), the node in monitor mode can inspect a sequence of packets and determine that a subset of them was sent by the same sender.

An application running on a node can send messages of predetermined lengths. For example, an application may send a message that it knows to be 3 bytes long in a single packet. That 3-byte message will typically be encrypted according to one of several encryption standards, and a header will be added to the message to form the packet's payload.

In some wireless standards, each packet's message length may be available to a node in monitor mode. In other wireless standards, the packet's message length will not be available, but the packet's payload length will be. Because encryption headers are of a consistent length, the difference between packets' message length and payload length should be constant on the same network connection.

In one embodiment, each of node A 110 and node B 120 include an encoder/decoder application 114 and 124, respectively. Encoder/decoder application 114 on node A 110 may be configured to encode a message 118 in the packet sequence 116 that can be read and decoded by encoder/decoder application 124 on node B 120, even though there is no direct connection between node A 110 and node B 120. In one embodiment, the message 118 is encoded using the packet lengths of the individual packets in packet sequence 116. In other embodiments, the message 118 is encoded using some other characteristic of packet sequence 116. Additional details of encoder/decoder applications 114, 124 are provided below.

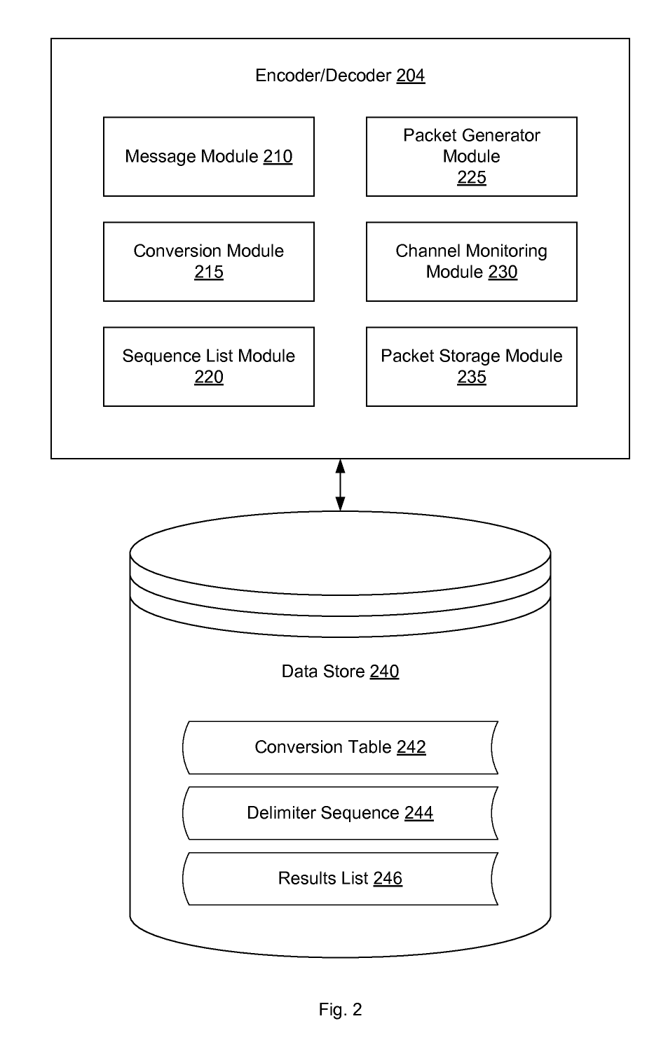

FIG. 2 is a block diagram illustrating an encoder/decoder 204, according to an embodiment. In one embodiment, encoder/decoder 204 includes message module 210, conversion module 215, sequence list module 220, packet generator module 225, channel monitoring module 230 and packet storage module 235. This arrangement of modules and components may be a logical separation, and in other embodiments, these modules or other components can be combined together or separated in further components, according to a particular embodiment. In one embodiment, data store 240 is connected to encoder/decoder 204 and includes conversion table 242, delimiter sequence 244 and results list 246. In one embodiment, encoder/decoder 204 may be representative of one or both of encoder/decoders 114, 124, as shown in FIG. 1. In one embodiment a single node (e.g., node A 110 or node B 120) may include both encoder/decoder 204 and data store 240. In another embodiment, data store 240 may be external to the node and may be connected to the node over a network or other connection. In other embodiments, encoder/decoder 204 may include different and/or additional components which are not shown to simplify the description. Data store 240 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, message module 210 receives a message to be transmitted to another non-connected node. In one embodiment, message module 210 provides a user interface which can receive user input specifying the message. In another embodiment, message module 210 uses an application programming interface (API) to receive the message from another program or from an operating system on the node. In one embodiment, for example, the message may include a character string, including letters, numbers and/or symbols, that makes up a network password, passcode, or encryption key. In other embodiments, the message may be some other piece of data.

In one embodiment, conversion module 215 converts the character string of the message to numerical values. For example, conversion module 215 may use the American Standard Code for Information Interchange (ASCII) codes for each character. Table 1 shows an example of the ASCII codes that may be used. Table 1 may be one example of conversion table 242 stored in data store 240.

TABLE 1

| Dec | Hx | Oct | Char | Dec | Hx | Oct | Html | Chr | Dec | Hx | Oct | Html | Chr | Dec | Hx | Oct | Html | Chr |
|---|---|---|---|---|---|---|---|---|---|---|---|---|---|---|---|---|---|---|
| 0 | 0 | 000 | NUL (null) | 32 | 20 | 040 | &#32; | Space | 64 | 40 | 100 | &#64; | @ | 96 | 60 | 140 | &#96; | \grave{ } |
| 1 | 1 | 001 | SOH (start of heading) | 33 | 21 | 041 | &#33; | ! | 65 | 41 | 101 | &#65; | A | 97 | 61 | 141 | &#97; | a |
| 2 | 2 | 002 | STX (start of text) | 34 | 22 | 042 | &#34; | ″ | 66 | 42 | 102 | &#66; | B | 98 | 62 | 142 | &#98; | b |
| 3 | 3 | 003 | ETX (end of text) | 35 | 23 | 043 | &#35; | # | 67 | 43 | 103 | &#67; | C | 99 | 63 | 143 | &#99; | c |
| 4 | 4 | 004 | EOT | 36 | 24 | 044 | &#36; | $ | 68 | 44 | 104 | &#68; | D | 100 | 64 | 144 | &#100; | d |
| | | | (end of transmission) | | | | | | | | | | | | | | | |
| 5 | 5 | 005 | ENQ (enquiry) | 37 | 25 | 045 | &#37; | % | 69 | 45 | 105 | &#69; | E | 101 | 65 | 145 | &#101; | e |
| 6 | 6 | 006 | ACK (acknowledge) | 38 | 26 | 046 | &#38; | & | 70 | 46 | 106 | &#70; | F | 102 | 66 | 146 | &#102; | f |
| 7 | 7 | 007 | BEL (bell) | 39 | 27 | 047 | &#39; | ' | 71 | 47 | 107 | &#71; | G | 103 | 67 | 147 | &#103; | g |
| 8 | 8 | 010 | BS (backspace) | 40 | 28 | 050 | &#40; | ( | 72 | 48 | 110 | &#72; | H | 104 | 68 | 150 | &#104; | h |
| 9 | 9 | 011 | TAB (horizontal tab) | 41 | 29 | 051 | &#41; | ) | 73 | 49 | 111 | &#73; | I | 105 | 69 | 151 | &#105; | i |
| 10 | A | 012 | LF (NL line feed, | 42 | 2A | 052 | &#42; | * | 74 | 4A | 112 | &#74; | J | 106 | 6A | 152 | &#106; | j |
| | | | new line) | | | | | | | | | | | | | | | |
| 11 | B | 013 | VT (vertical tab) | 43 | 2B | 053 | &#43; | + | 75 | 4B | 113 | &#75; | K | 107 | 6B | 153 | &#107; | k |
| 12 | C | 014 | FF (NP form feed, | 44 | 2C | 054 | &#44; | , | 76 | 4C | 114 | &#76; | L | 108 | 6C | 154 | &#108; | l |
| | | | new page) | | | | | | | | | | | | | | | |
| 13 | D | 015 | CR (carriage return) | 45 | 2D | 055 | &#45; | − | 77 | 4D | 115 | &#77; | M | 109 | 6D | 155 | &#109; | m |
| 14 | E | 016 | SO (shift out) | 46 | 2E | 056 | &#46; | . | 78 | 4E | 116 | &#78; | N | 110 | 6E | 156 | &#110; | n |
| 15 | F | 017 | SI (shift in) | 47 | 2F | 057 | &#47; | / | 79 | 4F | 117 | &#79; | O | 111 | 6F | 157 | &#111; | o |
| 16 | 10 | 020 | DLE (data link escape) | 48 | 30 | 060 | &#48; | 0 | 80 | 50 | 120 | &#80; | P | 112 | 70 | 160 | &#112; | p |
| 17 | 11 | 021 | DC1 (device control 1) | 49 | 31 | 061 | &#49; | 1 | 81 | 51 | 121 | &#81; | Q | 113 | 71 | 161 | &#113; | q |
| 18 | 12 | 022 | DC2 (device control 2) | 50 | 32 | 062 | &#50; | 2 | 82 | 52 | 122 | &#82; | R | 114 | 72 | 162 | &#114; | r |
| 19 | 13 | 023 | DC3 (device control 3) | 51 | 33 | 063 | &#51; | 3 | 83 | 53 | 123 | &#83; | S | 115 | 73 | 163 | &#115; | s |
| 20 | 14 | 024 | DC4 (device control 4) | 52 | 34 | 064 | &#52; | 4 | 84 | 54 | 124 | &#84; | T | 116 | 74 | 164 | &#116; | t |
| 21 | 15 | 025 | NAK (negative | 53 | 35 | 065 | &#53; | 5 | 85 | 55 | 125 | &#85; | U | 117 | 75 | 165 | &#117; | u |
| | | | acknowledge) | | | | | | | | | | | | | | | |
| 22 | 16 | 026 | SYN (synchronous | 54 | 36 | 066 | &#54; | 6 | 86 | 56 | 126 | &#86; | V | 118 | 76 | 166 | &#118; | v |
| | | | idle) | | | | | | | | | | | | | | | |
| 23 | 17 | 027 | ETB (end of | 55 | 37 | 067 | &#55; | 7 | 87 | 57 | 127 | &#87; | W | 119 | 77 | 167 | &#119; | w |
| | | | trans. block) | | | | | | | | | | | | | | | |
| 24 | 18 | 030 | CAN (cancel) | 56 | 38 | 070 | &#56; | 8 | 88 | 58 | 130 | &#88; | X | 120 | 78 | 170 | &#120; | x |
| 25 | 19 | 031 | EM (end of medium) | 57 | 39 | 071 | &#57; | 9 | 89 | 59 | 131 | &#89; | Y | 121 | 79 | 171 | &#121; | y |
| 26 | 1A | 032 | SUB (substitute) | 58 | 3A | 072 | &#58; | : | 90 | 5A | 132 | &#90; | Z | 122 | 7A | 172 | &#122; | z |
| 27 | 1B | 033 | ESC (escape) | 59 | 3B | 073 | &#59; | ; | 91 | 5B | 133 | &#91; | [ | 123 | 7B | 173 | &#123; | { |
| 28 | 1C | 034 | FS (file separator) | 60 | 3C | 074 | &#60; | < | 92 | 5C | 134 | &#92; | \ | 124 | 7C | 174 | &#124; | \| |
| 29 | 1D | 035 | GS (group separator) | 61 | 3D | 075 | &#61; | = | 93 | 5D | 135 | &#93; | ] | 125 | 7D | 175 | &#125; | } |
| 30 | 1E | 036 | RS (record separator) | 62 | 3E | 076 | &#62; | > | 94 | 5E | 136 | &#94; | \hat{ } | 126 | 7E | 176 | &#126; | ~ |
| 31 | 1F | 037 | US (unit separator) | 63 | 3F | 077 | &#63; | ? | 95 | 5F | 137 | &#95; | _{—} | 127 | 7F | 177 | &#127; | DEL |

In one embodiment, conversion module 215 uses the ASCII code for each character in the message. An ASCII code can be represented with an 8-bit number, and thus each character in the message corresponds to one 8-bit number. In other embodiments, some other mapping between ASCII characters and the numerical codes may be used. For example, if the message is “Hello”, the sequence of numbers taken from the Table 1 above is 72-101-108-108-111.

In one embodiment, sequence list module 220 identifies a delimiter sequence 244 known to both of the unconnected nodes and generates a list of packet lengths including the numerical values determined by conversion module 215 separated by the delimiter sequence. In this example the delimiter sequence 244 uses a base value of 500 bytes and has three values where each value increases by one: [500, 501, 502]. Sequence list module 220 appends the base value to each of the numerical values. For example when the numerical value is 72, and the base is 500, the appended value would be 572. Applying the above algorithm to the example message “Hello” (corresponding to values 72, 101, 108, 108, and 111) results in list of packets lengths [500, 501, 502, 572, 500, 501, 502, 601, 500, 501, 502, 608, 500, 501, 502, 608, 500, 501, 502, 611], where each number representing a message character is underlined. In other embodiments, some other delimiter sequence or some other format may be used.

In one embodiment, packet generator module 225 generates a packet sequence 116 with packet lengths corresponding to the values in the list of packet lengths generated by sequence list module 220. The network communication circuitry 112 on the corresponding node (e.g., node A 110) may transmit the packet sequence 116 to a connected node (e.g., node C 130) over network 140). In one embodiment, the packet sequence is transmitted multiple times for robustness (e.g., 1000 times).

In one embodiment, channel monitoring module 230 monitors a plurality of communication channels in network 140. Channel monitoring module 230 may monitor the channels looking for occurrences of the delimiter sequence 244 in data sent from a single transmitter node. When channel monitoring module 230 identifies an occurrence of the delimiter sequence 244, packet storage module 235 may record the packets sent by the transmitter node in a results list 246. In one embodiment, packet storage module 235 may store copies of the entire packets. In one embodiment, packet storage module 235 may store an indication of each of the packet lengths. In one embodiment, packet storage module 235 may store statistical summary data of the packet stream, such as a length of the most recently received packet, a difference in size from the previously received packet, and how many packets in a row have increased in size by a fixed amount (e.g., 1 byte).

When a node (e.g., node B 120) is in monitor mode it will see packets from all nearby nodes, including packets that are not from node A 110, and packets that are from node A 110 but are not from the sending application 114 on node A 110. In addition, node B 120 will not necessarily know in advance the precise electromagnetic spectrum (channel) on which node A 110 and node C 130 are connected. Node B 120 will therefore scan different channels in succession, looking for a predetermined sequence of packets with payload lengths that matches the pattern of the delimiter sequence 244. In one embodiment, node B 120 enters a sender acquisition loop, wherein it repeatedly scans through all channels looking for a sequence of packets, which originates from a single sending node and matches the relative length pattern known to be used by the sender.

Because the sender has control of the message length, and because the receiver may have access to the payload length, the receiver may not be able to directly identify the message length pattern. Instead, the receiver transforms both the payload length pattern into a relative-length pattern by subtracting the first number in the pattern from all numbers in the pattern. For example, the following two length patterns will have the same relative-length pattern:

Length Pattern 1: [500, 501, 502, 500+X, 500, 501, 502, 500+X, 500, 501, 502, 500+X, 500, 501, 502].

Length Pattern 2: [100, 101, 102, 100+X, 100, 101, 102, 100+X, 100, 101, 102, 100+X, 100, 101, 102].

Relative-length Pattern for both: [0, 1, 2, X, 0, 1, 2, X, 0, 1, 2, X, 0, 1, 2].

Message length typically has a consistent relationship to payload length. For example, in Wi-Fi networks, once an encryption standard has been established between two nodes, all packets shared between those two nodes will have encryption headers of the same length. Because the difference between a packet's message length and payload length is the length of the encryption header, the difference between a packet's message length and payload length will remain constant for all packets shared on a single connection. Therefore, the relative patterns for the message length and the payload length of a set of packets will be the same.

When the receiver encounters the relative length pattern in the payload lengths, it records the unique identifier of the sending node and the channel in which the packets are being sent. After a sender is found, node B 120 stays on that channel and continues to monitor packets on that channel, but can drop all packets that are not from the sender's MAC address.

Node B 120 now records all packets coming from the MAC address of the sender in results list 246, looking for all incoming subsequences of packets that exactly match the relative length pattern [0, 1, 2, X, 0, 1, 2]. Each time it finds one of these patterns it appends the value of X to its result list 246. It can continue to do this until it has not found the pattern for some period of time, for example 10 seconds.

In one embodiment, conversion module 215 converts the result list 246 to a list of message characters by reversing the sender's encoding. For example, conversion module 215 can use conversion table 242 to determine the ASCII characters. For example, if results list 246 includes [70, 79, 111, 100], the character string will be “FOod”. In practice, the character string will be much longer because the sender transmitted the message 1000 times. Characters in the string may also be wrong, dropped, or added due to the network characteristics, such as lossiness, retransmission, reordering and multiple applications. For example, using the message “Hello”, the decoded character string may actually be:

“HeoellHelloHaaloloollHelloelloHezzHelloloHello . . . ”

The original out-of-band message (i.e., “Hello”) is contained within the character string, but an additional layer of encoding may be useful to facilitate extraction of the message, given the errors in transmission created resulting from the network characteristics.

One technique is to use a fixed message length, with special start and end sequences. For example, a length of 10 characters can be used for the fixed length, with start sequence “12” and end sequence “89”. So the out-of-band message “Hello” would become “12Hello_{—}89”.

So if the sender transmits out-of-band-message “12Hello_{—}89” a received set of characters using the sender and receiver algorithms above might be:

“12Hel82Hll8912Hello_{—}89hall12Heallo89ello_{—}2He8912Hello_{—}89”

The receiver knows to look for subsequences of length 10, starting with “12” and ending with “89” (call these Y). Valid subsequences are underlined above, of which there are three. The receiver may choose the most common subsequence Y as the intended out-of-band-message. Alternatively, the sender may append a checksum digit or hash code in the original message that, when decoded, will provide higher confidence in the integrity of the message. In other embodiments, instead of the most common subsequence, a checksum or hash may be used as a more robust mechanism for proving data integrity.

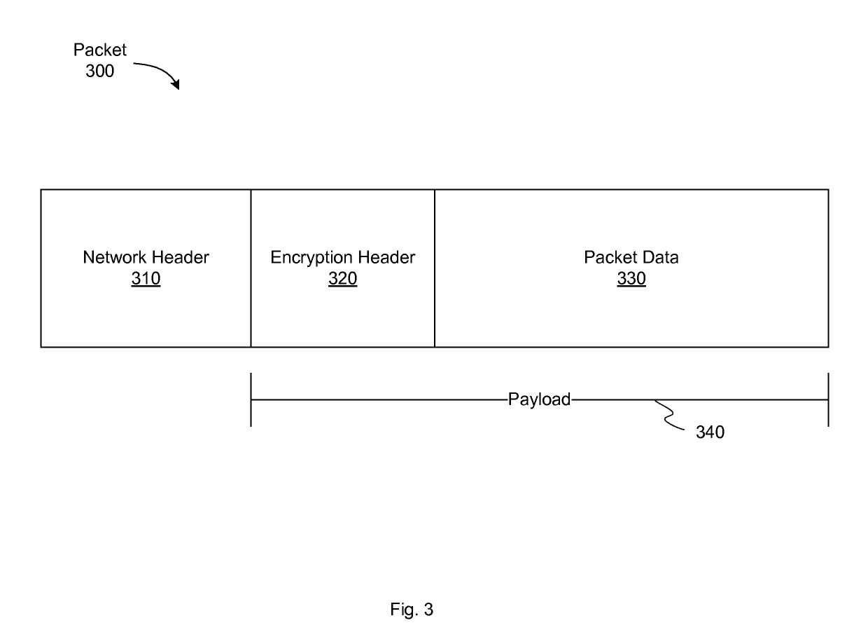

FIG. 3 is a block diagram illustrating a network packet 300, according to an embodiment. Network packet 300 may one an example of one of the packets sent by node A 110 to node C 120 in packet sequence 116. In one embodiment, the length of network packet 300 may be used to encode at least part of the message 118 sent from node A 110 to node B 120. In one embodiment, network packet 300 includes network header 310, encryption header 320 and packet data 330. Together, encryption header 320 and packet data 330 may make up the payload 340 of the packet. Network header 310 is a subcomponent of packet 300 which contains control information, such as the MAC address of the sending node of the packet and the intended target of the packet. Encryption header 320 is a subcomponent of packet 300 which contains information relating to the encryption of the message. Encryption is the process of encoding messages or information so that eavesdroppers cannot read it, but authorized parties can. Encryption is used to protect data in transit in a network. An encryption key or keys are typically used to specify how the data should be encoded. Both the sender and receiver of an encrypted message must have knowledge of the encryption key. Packet data 330 is a piece of information that can be transmitted from one node to another. In one embodiment, the packet data 330 includes dummy data that is used to set the packet length in order to encode part of the message 118. Packet length typically has a consistent relationship to payload length 340. For example, in Wi-Fi networks, once an encryption standard has been established between two nodes, all packets shared between those two nodes will have encryption headers of the same length. Because the difference between a packet's data length and payload length is the length of the encryption header 320, the difference between a packet's data length and payload length will remain constant for all packets shared on a single connection. Therefore, the relative patterns for the data length and the payload length of a set of packets will be the same.

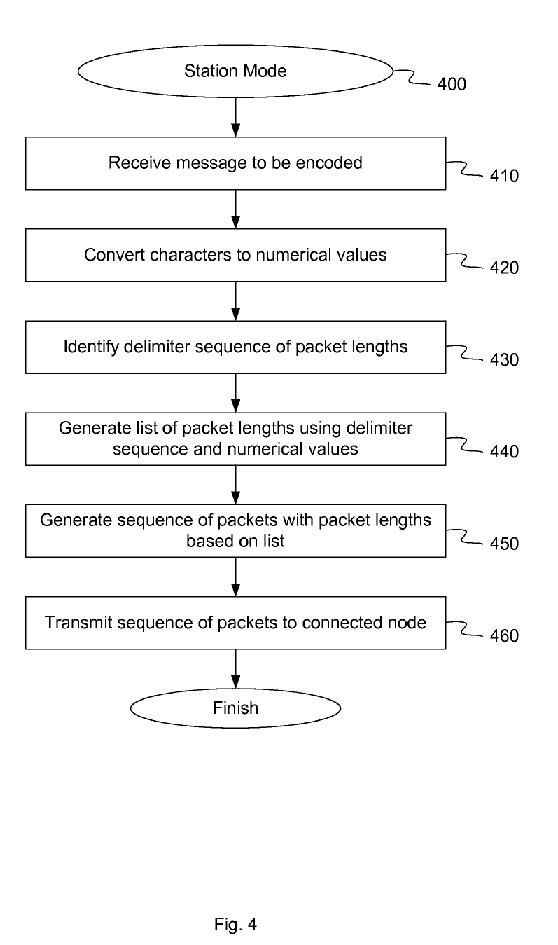

FIG. 4 is a flow diagram illustrating a method for communication of device operating in a station mode, according to an embodiment. The method 400 may be performed by processing logic that comprises hardware (e.g., circuitry, dedicated logic, programmable logic, microcode, etc.), software (e.g., instructions run on a processing device to perform hardware simulation), or a combination thereof. The method 400 encodes, at a first node, a message intended for a second node in the packet lengths of a sequence of packets sent from the first node to a third node. In one embodiment, method 400 may be performed by an encoder/decoder 204, as shown in FIGS. 1 and 2.

Referring to FIG. 4, at block 410, method 400 receives, at a first node, a message to be encoded and provided to a second node. In one embodiment, message module 210 of encoder/decoder 112 on node A 110 receives the message.

At block 420, method 400 converts each character in a character string of the message to a numerical value. In one embodiment, conversion module 215 converts each character to a numerical value using conversion table 242.

At block 430, method 400 identifies a delimiter sequence of packet lengths that is known to both the first node and the second node. In one embodiment, sequence list module 220 identifies delimiter sequence 244 stored in data store 240.

At block 440, method 400 generates a list of packet lengths with packet lengths corresponding to the numerical values separated by the delimiter sequence of packet lengths. In one embodiment, sequence list module 220 appends the base value to each of the numerical values and creates a list starting with the delimiter sequence 244, followed by the first numerical value, followed by the delimiter sequence 244, followed by the second numerical value, and so on.

At block 450, method 400 generates a sequence of packets having packet lengths corresponding to the list of packet lengths. In one embodiment, packet generator module 225 generates a packet sequence 116 with packet lengths corresponding to the values in the list of packet lengths generated at block 440.

At block 460, method 400 transmits the sequence of packets from the first node to the third node. In one embodiment, the network communication circuitry 112 on node A 110 may transmit the packet sequence 116 to a connected node (e.g., node C 130) over network 140). In one embodiment, the packet sequence is transmitted multiple times (e.g., 1000 times).

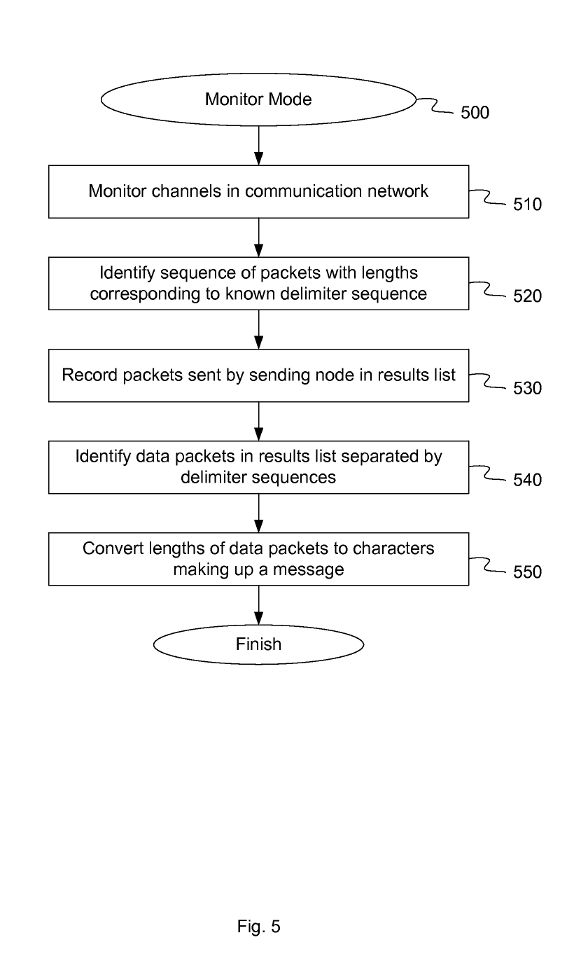

FIG. 5 is a flow diagram illustrating a method for communication of device operating in a monitor mode, according to an embodiment. The method 500 may be performed by processing logic that comprises hardware (e.g., circuitry, dedicated logic, programmable logic, microcode, etc.), software (e.g., instructions run on a processing device to perform hardware simulation), or a combination thereof. The method 500 decodes, at a second node, a message intended for the second node using the packet lengths of a sequence of packets sent from a first node to a third node. In one embodiment, method 500 may be performed by an encoder/decoder 204, as shown in FIGS. 1 and 2.

Referring to FIG. 5, at block 510, method 500 monitors a plurality of communication channels in a communication network. In one embodiment, channel monitoring module 230 in encoder/decoder 124 of node B 120 periodically rotates through the communication channels in network 140.

At block 520, method 500 identifies a sequence of packets sent on one of the plurality of communication channels from a first mode and having packet lengths corresponding to a known delimiter sequence. In one embodiment, channel monitoring module 230 identifies occurrences of the delimiter sequence 244 in data sent from a single transmitter node.

At block 530, method 500 records packets sent by the first node in a results list. In one embodiment, when channel monitoring module 230 identifies an occurrence of the delimiter sequence 244, packet storage module 235 may record the packets sent by the transmitter node in a results list 246 in data store 240.

At block 540, method 500 identifies a number of data packets from the results lists that are separated by the sequence of packets having packet lengths corresponding to the known delimiter sequence. In one embodiment, sequence list module 220 sorts out the values in results list 246 corresponding to the delimiter sequence 244 and subtracts the base value from each of the packet lengths corresponding to the interspersed data packets.

At block 550, method 500 converts the lengths of the data packets to characters in a character string comprising a message intended for the second node. In one embodiment, conversion module 215 converts the numerical values into characters using conversion table 242. The resulting character string may represent the message 118 sent by node A 110 to unconnected node B 120.

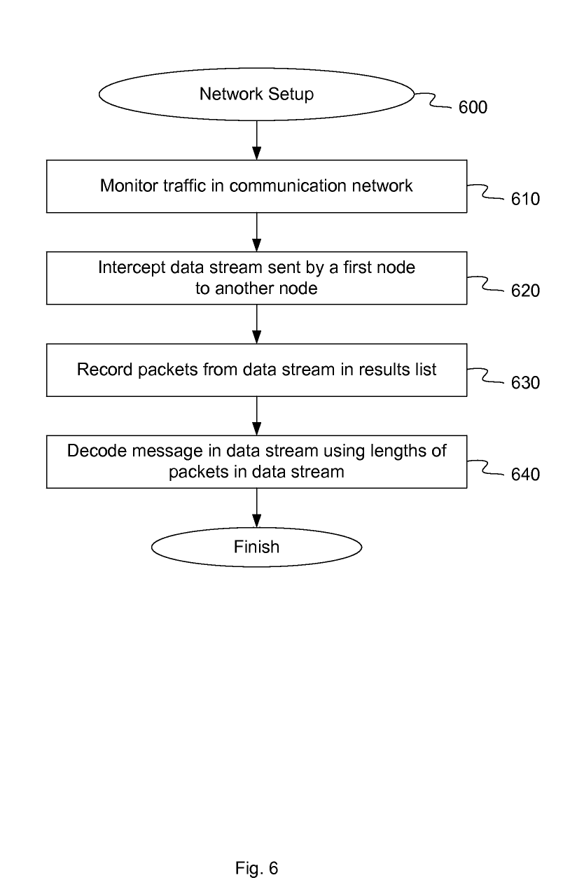

FIG. 6 is a flow diagram illustrating a method for communication network setup, according to an embodiment. The method 600 may be performed by processing logic that comprises hardware (e.g., circuitry, dedicated logic, programmable logic, microcode, etc.), software (e.g., instructions run on a processing device to perform hardware simulation), or a combination thereof. The method 600 passes a network password from a first node to a second node when there is no connection between the first node and the second node to enable the second node to connect to the network. In one embodiment, method 600 may be performed by an encoder/decoder 204, as shown in FIGS. 1 and 2.

Referring to FIG. 6, at block 610, method 600 monitors network traffic in a communication network. In one embodiment, channel monitoring module 230 in encoder/decoder 124 of node B 120 periodically rotates through the communication channels in network 140.

At block 620, method 600 intercepts a data stream in the network traffic that is sent by a first node to a another node with which it has a connection. In one embodiment, channel monitoring module 230 identifies occurrences of the delimiter sequence 244 in data sent from a single transmitter node (e.g., node A 110).

At block 630, method 600 records packets from the data stream in a results list. In one embodiment, when channel monitoring module 230 identifies an occurrence of the delimiter sequence 244, packet storage module 235 may record the packets sent by the transmitter node in a results list 246 in data store 240.

At block 640, method 600 decodes a message in the data stream intended for a second node using lengths of a plurality of packets in the data stream. In one embodiment, sequence list module 220 sorts out the values in results list 246 corresponding to the delimiter sequence 244 and subtracts the base value from each of the packet lengths corresponding to the interspersed data packets. Conversion module 215 then converts the numerical values into characters using conversion table 242. The resulting character string may represent the message 118 sent by node A 110 to unconnected node B 120.

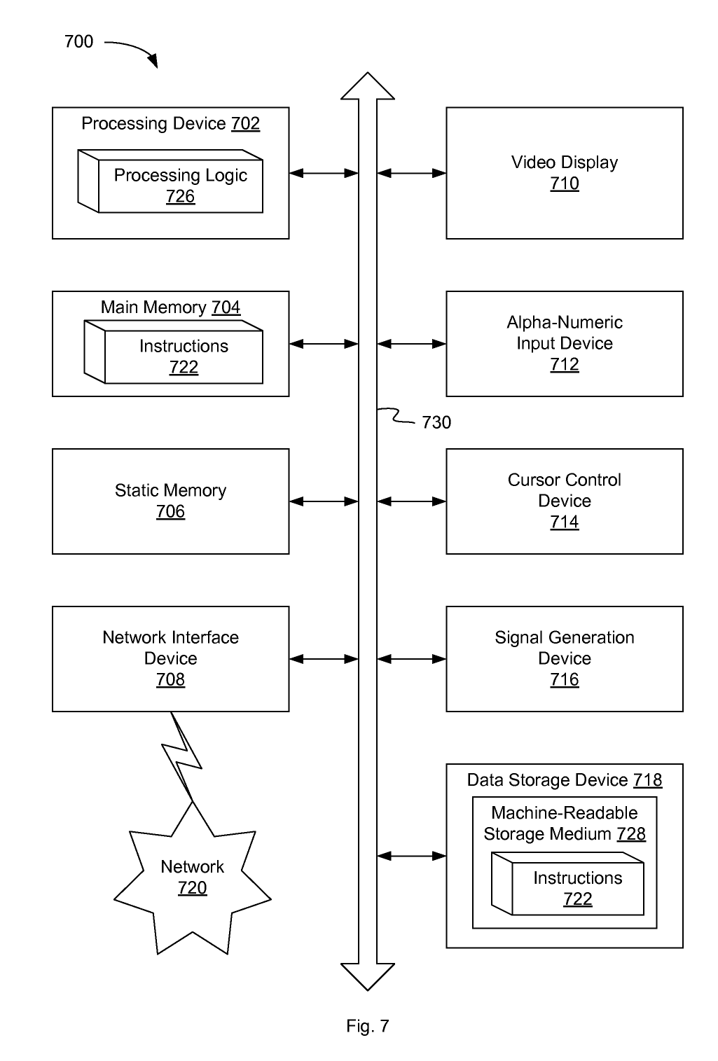

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of node A 110, node B 120 or node C 130, as shown in FIG. 1.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-readable storage medium 728, on which is stored one or more set of instructions 722 (e.g., software) embodying any one or more of the methodologies of functions described herein. The instructions 722 may also reside, completely or at least partially, within the main memory 704 and/or within the processing device 702 during execution thereof by the computer system 700; the main memory 704 and the processing device 702 also constituting machine-readable storage media. The instructions 722 may further be transmitted or received over a network 720 via the network interface device 708.

The machine-readable storage medium 728 may also be used to store instructions to perform a method for communication between network nodes that are not directly connected, as described herein. While the machine-readable storage medium 728 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the media server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the web server or media server.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method comprising:
receiving, at a first node, a message to be encoded and provided to a second node, wherein the message comprises a character string, and wherein the first node and the second node are not connected;
converting each character in the character string of the message to a numerical value;
identifying a delimiter sequence of packet lengths, wherein the delimiter sequence is known to the first node and the second node;
generating, by a processing device at the first node, a list of packet lengths, wherein the list of packet lengths comprises packet lengths corresponding to the numerical values separated by the delimiter sequence of packet lengths;
generating a sequence of packets having packet lengths corresponding to the list of packet lengths; and
transmitting the sequence of packets from the first node to a third node, wherein the first node and the third node are connected over a communication network.

2. The method of claim 1, wherein the message to be encoded comprises a password to enable access to the communication network.

3. The method of claim 1, wherein the numerical values comprise American Standard Code for Information Interchange (ASCII) codes corresponding to each character in the character string of the message.

4. The method of claim 1, wherein the delimiter sequence of packet lengths comprises a fixed number of packet lengths where each length in the sequence increases by a fixed amount.

5. The method of claim 1, wherein generating the sequence of packets comprises generating packets of dummy data having packet lengths corresponding to the list of packet lengths.

6. The method of claim 1, wherein the list of packet lengths comprises a fixed number of packet lengths and comprises a start of message indicator and an end of message indicator.

7. The method of claim 1, wherein the second node to intercept the sequence of packets and decode the message.

8. A non-transitory machine-readable storage medium storing instructions which, when executed, cause a processing device to perform operations comprising:
monitoring a plurality of communication channels in a communication network;
identifying a sequence of packets sent on one of the plurality of communication channels from a first node, the sequence of packets having packet lengths corresponding to a known delimiter sequence;
recording a plurality of packets sent by the first node in a results list stored at a second node, wherein the first node and the second node are not connected, wherein the plurality of packets is sent from the first node to a third node, the first node and the third node being connected over the communication network;
identifying, by the processing device at the second node, a number of data packets from the results list, wherein the data packets are separated by the sequence of packets having packet lengths corresponding to the known delimiter sequence;
converting a length of each data packet to a character in a character string, the character string comprising a message intended for the second node.

9. The non-transitory machine-readable storage medium of claim 8, wherein the length of each data packet corresponds to an American Standard Code for Information Interchange (ASCII) code for each character in the character string.

10. The non-transitory machine-readable storage medium of claim 8, wherein the known delimiter sequence comprises a fixed number of packet lengths where each length in the sequence increases by a fixed amount.

11. The non-transitory machine-readable storage medium of claim 8, wherein the plurality of packets comprises packets of dummy data having packet lengths corresponding to numerical values representing the character string separated by the sequence of packets having packet lengths corresponding to the known delimiter sequence.

12. The non-transitory machine-readable storage medium of claim 8, wherein the plurality of packets comprises a fixed number of packets and comprises a start of message indicator and an end of message indicator.

13. The non-transitory machine-readable storage medium of claim 8, wherein the message intended for the second node comprises a password to enable access to the communication network.

14. The non-transitory machine-readable storage medium of claim 13, wherein the operations further comprise:
providing the password to the third node to gain access to the communication network.

15. A system comprising:
a first node;
a second node, wherein the first node and the second node are not connected; and
a third node, wherein the first node and the third node are connected over a communication network,
wherein the second node is configured to:
monitor network traffic in the communication network;
intercept a data stream in the network traffic sent from the first node to the third node; and
decode a message in the data stream intended for the second node,
wherein the message is encoded using lengths of a plurality of packets in the data stream.

16. The system of claim 15, wherein the data stream in the network traffic comprises a packets having packet lengths corresponding to numerical values representing characters in the message separated by a sequence of packets having packet lengths corresponding to a known delimiter sequence.

17. The system of claim 16, wherein the data stream in the network traffic is recognized by a repeating sequence of packets having packet lengths corresponding to the known delimiter sequence.

18. The system of claim 16, wherein the numerical values comprise American Standard Code for Information Interchange (ASCII) codes corresponding to each character in the message.

19. The system of claim 15, wherein the message intended for the second node comprises a password to enable access to the communication network.

20. The system of claim 19, wherein the second node is further configured to:
providing the password to the third node to gain access to the communication network.
